(19) United States
(12) Patent Application Publication
(10) Pub. No.: US 2012/0047491 A1
(43) Pub. Date: Feb. 23, 2012

(54) SYSTEM WITH A PRODUCTION SYSTEM AND A PROTOTYPE SYSTEM, AND A METHOD FOR THE OPERATION THEREOF

(76) Inventor: Thomas Blum, Neunkirchen a. Brand (DE)

(21) Appl. No.: 13/213,265

(22) Filed: Aug. 19, 2011

(30) Foreign Application Priority Data
Aug. 19, 2010 (DE) 10 2010 039 519.6

(51) Int. Cl. G06F 9/44

(52) U.S. Cl. 717/127

(57) ABSTRACT

A computerized system has a production system for a data processing (in particular an image data processing) and a prototype system. The production system has a production runtime environment and the prototype system has a prototype runtime environment that is designed to be separate from the production runtime environment, and the prototype runtime environment is designed to be essentially identical to the production runtime environment.

### BACKGROUND OF THE INVENTION

1. Field of the Invention

The present invention concerns a system of the type having a production system for data processing, in particular image data processing, and a prototype system, wherein the production system has a first runtime environment and the prototype system has a second runtime environment that is designed to be separate from the production runtime environment. The invention also concerns a method for operating such a system.

2. Description of the Prior Art

In order to reasonably test a prototype system or a prototype application, it is necessary to use and/or operate the prototype system or the prototype application (which is formed by a prototype software application) together with a production system and/or data access from the prototype system to the production system. However, in medical information systems, particularly for medical image data processing, that are used with involvement of a patient, for example, it is only conditionally possible to operate prototype software applications that are not yet approved for clinical operation within this medical information system. The reasons for this are, for example, a high risk of patient data loss and/or a high risk of (in particular negative) influencing the patient operation or operation of the production system by the only insufficiently tested prototype software applications.

However, in exceptional cases a limited use authorization of prototype software applications can be enabled with the approval of an operator (a clinic, for example). Such limited use authorizations are possible in an evaluation of new image data processing algorithms in research, for example.

To circumvent this problem, systems are known in which prototype applications are arranged on a runtime environment separated from a production system. The separated runtime environment is arranged on a computer that is designed to be separate from a computer employed by the production system. However, this method has the disadvantage that a direct data exchange between the production system and the prototype system is not possible. Data for a data exchange must thus be copied in a complicated manner from the production system to the prototype system in order to protect the production system from being adversely influenced by the prototype system. In particular, operating sequences that are based on a common use of data and/or intermediate results by means of the prototype applications and/or by means of production applications thus cannot be realized.

Furthermore, it is known to generate a separated runtime environment within an existing information system by means of virtual machines. However, in many medical information systems the use of these virtual machines is not authorized since these represent a risk to the production system.

### SUMMARY OF THE INVENTION

An object of the present invention is to provide a particularly stable system with an interference-free operation of a production system during an operation of a prototype system in an effective test environment of the prototype system.

The invention proceeds from a system with a production system for a data processing (in particular image data processing) and a prototype system, wherein the production system has a production runtime environment and the prototype system has a prototype runtime environment that is designed to be separate from the production runtime environment.

In accordance with the invention, the prototype runtime environment is designed to be essentially identical to the production runtime environment. In this context a prototype system means a system that has at least one prototype application and/or one prototype unit that must still be authorized for routine or “normal” operation within a production system and thus must be tested for this purpose. A production system means a system with which regular operation takes place with data processing, in particular medical image data processing. In particular in medical systems, any change and/or influencing of the production system is unwanted since this can lead to disruptions and/or failures of the production system (and therefore of a patient operation). Furthermore, a runtime operation means an execution environment and/or a computer program by means of which the application programs and/or application software (in particular platform-independent and/or operating system-independent application programs and/or application software) can be executed. The prototype runtime environment that is designed to be separated from the production runtime environment is advantageously fashioned as a sandbox, and is designed such that at least one software item and/or at least one computer program of the prototype system is/are shielded from an additional system (in particular the production system) so that a disruption of and/or negative effect on the additional system (in particular the production system) is prevented, and in addition the effect of the software item and/or of the computer program of the prototype system can be recorded for a subsequent analysis of the prototype system, for example.

In the embodiment according to the invention, the prototype system can be tested independently of the production system so that a negative effect on the production system due to the prototype system can be precluded. A particularly stable system and a stable and disruption-free operation of the production system can be obtained in such a manner. Due to the essentially identical runtime environments in the production system and the prototype system, the prototype system—in particular individual prototype applications—can additionally be tested within and/or in an environment of the production system, and therefore a particularly effective test environment for the production system can be achieved. The prototype runtime environment thus includes a protected area that is designed to be identical to the production runtime environment so that a runtime environment foreign to the system is avoided for the prototype runtime environment. Due to the similarly designed runtime environments of the two systems, at least some direct access to data of the production system by the prototype system is allowed.

Furthermore, in accordance with the invention the prototype system has at least one operator interface unit that is designed to be separate from at least one operator interface unit of the production system. An operator interface unit is an interface of the production system and/or of the prototype system for an operator and/or user of the system, for example a client user interface. The operator interface unit can be a graphical user interface, for example a user menu presented on a monitor for an input and/or output of information to or from the operator. A restrictive separation between the production system and the prototype system can be achieved so that an unwanted negative effect on the production system (in particular the user interface unit of the production system, for example in a medical operating mode) by the prototype system (in particular the prototype runtime environment) can advantageously be prevented.

The at least one operator interface unit of the prototype system can be at least one computer that is designed to be separate from at least one computer of the at least one operator interface unit of the production system. As used herein a computer means a unit that includes a processor and/or a memory unit and/or additional units such as a graphical user interface for the operator, for example a monitor. The production system and/or the prototype system each can have multiple operator interface units, each of the operator interface units possessing its own separate computer. In an alternative embodiment of the invention, an implementation of the two separated runtime environments on a common computer is also conceivable.

A particularly advantageous use of production applications of the production system by the prototype system can be achieved while avoiding an unwanted negative effect on an operation of the production system in an embodiment of the invention wherein the at least one operator interface unit of the prototype system has at least one production application and at least one prototype application. A prototype application can additionally run and/or be applied in an environment and/or an interaction with the production application, and thus a particularly effective test environment can be provided for the prototype application. An application in this context is application software and/or an application program.

In a further embodiment of the invention, the prototype system has a prototype server unit that is designed to be separate from a production server unit of the production system. A server unit means a unit on which an application software and/or server software and/or server programs run and/or are executed. For this purpose the server unit includes a processor and/or additional units appearing to be reasonable to those skilled in the art. A particularly restrictive separation between the production system and the prototype system thus can be achieved so that an unwanted negative effect on the production system—in particular in a medical operating mode of the production system—can advantageously be prevented by the prototype system.

The prototype server unit of the prototype system can be formed at least in part by a computer or a computer farm unit that is designed to be separate from a computer or a computer farm unit of the production server unit.

The production system can have a production data memory unit for storage of production data, and the prototype system can have at least some direct data access to the production data stored in the production data memory unit. A particularly dynamic data exchange thus can be achieved between the production system and the prototype system, and therefore the prototype system (in particular individual prototype applications) can be tested effectively. Common workflows and/or operating sequences that incorporate both the prototype system and the production system can hereby be additionally realized. The production data can be measurement results of the production system and/or intermediate results of the production system that have been at least partially evaluated.

Furthermore, a negative effect in the form of a disruption and/or a failure of the production system can be prevented and/or suppressed, and therefore the production system can advantageously be protected from an unauthorized access by the prototype system in an embodiment wherein the data access by the prototype system to the production data within the production data memory unit is at least partially limited. Data integrity of the production data thus can be additionally achieved. A limitation of the data access can be, for example, a read-only authorization. Alternatively designed limitations of the data access are possible.

The limitation of the data access by the prototype system to the production data within the production data memory unit can be at least partially configurable, so a particularly flexible prototype system that can be used for multiple purposes can be achieved, which can be adapted to respective data protocol designs and/or security precautions of a production system.

A particularly flexible data exchange between the prototype system and the production system can be achieved by the prototype system having at least one prototype data memory unit to store prototype data and the production system has unlimited data access to the prototype data stored in the prototype data memory unit.

In an alternative embodiment of the invention, the system has at least one common operating sequence into which at least one production application and at least one prototype application are integrated, so an effective test of the at least one prototype application can take place in a production environment. The at least one prototype application and the at least one production application of the at least one common operating sequence are executed within and/or during the prototype runtime environment independent of the production runtime environment and/or the production system.

The system according to the invention can be used in all data processing systems, in particular image data processing systems. Due to the restrictive separation of production system and prototype system that is required in clinical fields, however, the system according to the invention can be formed by a medical imaging system.

Furthermore, the invention proceeds from a method for an operation of a system, wherein at least one production application is executed on a production runtime environment and at least one prototype application is executed in a prototype runtime environment separated from the production runtime environment.

In the method according to the invention, the prototype runtime environment is essentially designed identical to the production runtime environment. The prototype system, in particular individual prototype applications, can be tested within and/or in an environment of the production system, and therefore a particularly effective test environment for the production system can be achieved. A particularly stable system and a stable and disruption-free operation of the production system can be obtained because influencing of the production system is prevented by the operation and/or test run of the prototype system.

A particularly dynamic data exchange can be achieved when direct data access takes place from a prototype system to a production system and/or from the production system to the prototype system.

Furthermore, a negative effect in the form of a disruption and/or a failure of the production system can be prevented and/or suppressed, and therefore the production system can be protected from an unauthorized access by the prototype system when the data access of the prototype system to the production system takes place in an at least partially limited manner. In addition, data integrity of the production data is achieved.

In an alternative embodiment of the method of the invention, at least one common operating sequence is executed with at least one production application and at least one prototype application, so an effective test of the at least one prototype application can take place in a production environment.

### BRIEF DESCRIPTION OF THE DRAWINGS

FIG. 1 shows the basic components of a system according to the invention with a production system and a prototype system.

FIG. 2 illustrates the system in a more detailed depiction.

### DESCRIPTION OF THE PREFERRED EMBODIMENTS

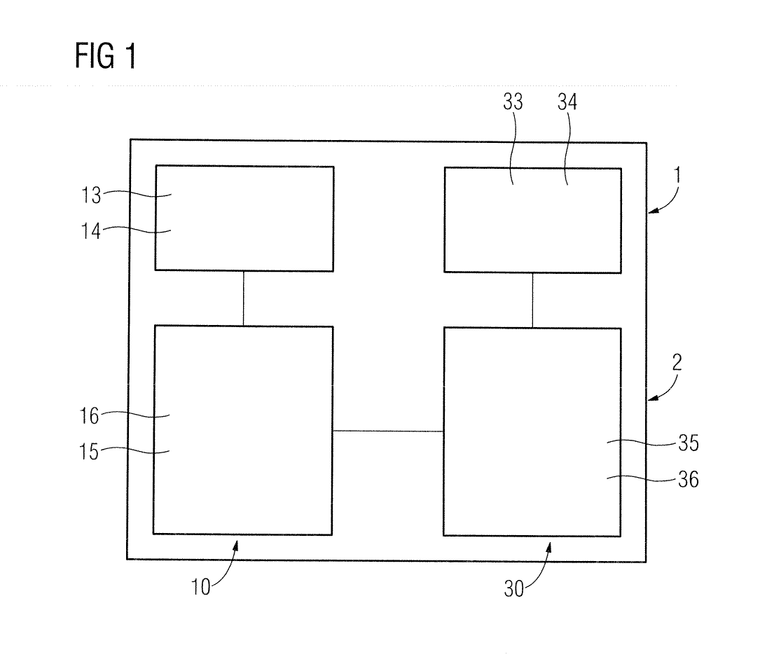

A system 1 according to the invention that is formed by a medical imaging system 2 is shown in FIG. 1. The medical imaging system 2 includes a production system 10 and a prototype system 30. In an operation of the medical imaging system 2 the production system 10 is designed for data processing—in particular image data processing—for the generation of medical images. The prototype system 30 is designed for a test and/or a trial of prototype applications, in particular software applications and/or computer program applications.

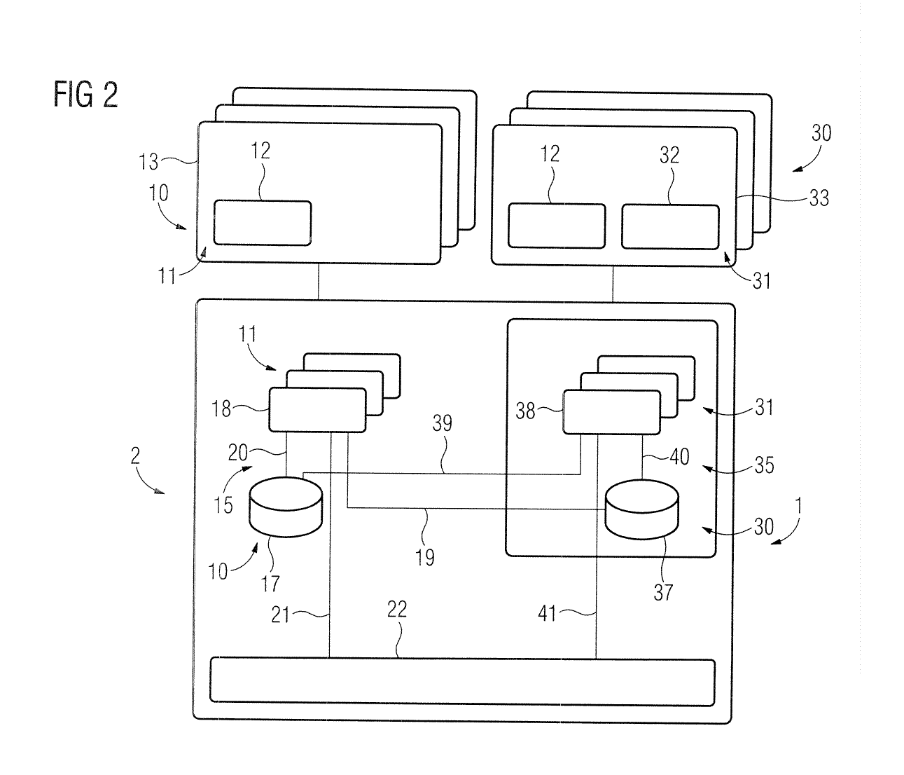

The production system 10 has a production server unit 15 that, in the present exemplary embodiment, includes a computer 16. As an alternative, the production server unit 15 can also include a computer farm unit and/or a server farm unit that are formed by multiple—in particular similar—server hosts. The production server unit 15 has a production data memory unit 17 for a storage of production data. A production runtime environment 11 and production applications 18 are also implemented at the production server unit 15, wherein the production applications 18 are executed in an operation of the production system 10 within the production runtime environment 11. The production applications 18 have an unlimited data access 20 to the production data stored within the production data memory unit 17 (FIGS. 1 and 2).

Furthermore, the production system 10 has an operator interface unit 13 that is designed as client user interface and that comprises a computer 14 (FIG. 1). As an alternative to this, the production system 10 can also have multiple operator interface units 13 that additionally respectively have a computer 14. Multiple production applications 12 of the production system 10 and the production runtime environment 11 are implemented in the operator interface unit 13, wherein the production applications 12 are executed within the production runtime environment 11 in an operation of the production system 10.

The production applications 12, 18 are formed by production application programs and/or production application software, for example an image data proximity software. The production applications 12, 18 are advantageously stored within an application memory unit (not shown in detail) of the production server unit 15 and/or the operator interface unit 13.

Within the production system 10 the production server unit 15 is connected with the operator interface unit 13 of the production system 10 by means of a data line.

The prototype system 30 is designed to be separate from production system 10. For this, in addition to the production system 10 the prototype system 30 has a prototype runtime environment 31 that is designed to be separate from the production runtime environment 11. In order to achieve a runtime environment within the prototype system 30 that is adapted as best possible to the production system 10, the prototype runtime environment 31 is designed to be essentially identical to the production runtime environment 11. During the operation of the medical imaging system 2, the prototype system 30 thus runs independent of the production system 10 due to the prototype runtime environment 31 separated from the production runtime environment 11, such that the production system 10 does not suffer any negative influence and/or disruption due to the prototype system 30. Due to the essentially identical design of the prototype runtime environment 31 of the prototype system 30 like the production runtime environment 11, the prototype runtime environment 30 does not form an environment foreign to the system but rather a protected region, in particular a protected test region within the medical imaging system 2 (FIG. 2).

Analogous to the embodiment of the production system 10, the prototype system 30 has a prototype server unit 35 that, in the present exemplary embodiment, comprises a computer 36 that is designed to be separate from the computer 16 of the production server unit 15 (FIG. 1). In an alternative embodiment of the medical imaging system 2, in particular of the prototype server unit 35, this can also be a computer farm unit and/or a server farm unit that are advantageously formed by multiple (in particular similar) server hosts. The prototype server unit 35 has a prototype data storage unit 37 for a storage of prototype data. Furthermore, prototype applications 38 and the prototype runtime environment 31 are implemented on the prototype server unit 35, wherein the prototype applications 38 are executed in an operation of the prototype system 30 within the prototype runtime environment 31. The prototype applications 38 have an unlimited data access 40 to the prototype data stored within the prototype data memory unit 37 (FIGS. 1 and 2).

The prototype system 30 likewise additionally has an operator interface unit 33 that is designed to be separate from the operator interface unit 13 of the production system 10. The operator interface unit 33 of the prototype system 30 is likewise designed as a client user interface and comprises a separate computer 34 that is designed to be divided and/or separate from the computer 14 of the production system 10 (FIGS. 1 and 2). Analogous to the production system 10, in an alternative embodiment of the medical imaging system 2 the prototype system 30 also has multiple operator interface units 33 that can each be a separate computer 34. At least one prototype application 32 of the prototype system 30 and the prototype runtime environment 31 is implemented in the operator interface unit 33 of the prototype system 30. In addition, the production applications 12 of the production system 10 are likewise implemented at the operator interface unit 33 of the prototype system 30 or, respectively, the prototype runtime environment 31, such that these production applications 12 are implemented twice in a runtime environment within the medical imaging system 2. In the operation of the prototype system 30, the at least one prototype application 32 and (at least in part) the production applications implemented in the prototype runtime environment 31 are executed within said prototype runtime environment 31.

The prototype applications 32, 38 are, for example, formed by an untested prototype software for an image data processing [sic] that, for example, at least one successful test operation within the prototype system must successfully exist for an operation and/or an implementation within the production system 10 and/or the production runtime environment 11. The prototype applications 32, 38 are advantageously stored within an application memory unit of the prototype server unit 35 and/or the operator interface unit 33 (not shown in detail).

Within the prototype system 30, the prototype server unit 35 is connected with the operator interface unit 33 of the prototype system 30 by means of a data line.

Due to the separated computers 14, 34, it is additionally ensured that an operation of the production system 10 can remain unaffected by failed runs and/or malfunctions within the prototype system 30, for example given a computer crash within the prototype system 30 and/or a program crash of a prototype application 32. Unwanted interactions can also additionally be prevented in such a manner between the prototype system 30 and the production system 10, in particular during an execution of prototype applications 32, 38. During an execution of the prototype system 30 within the operator interface unit 33 the prototype system 30 additionally has unlimited access to the production applications 12 implemented within the operator interface unit 33 of the prototype system 30, such that a particularly efficient test environment adapted to the production system is achieved for the prototype applications 32 of the prototype system 30.

The prototype runtime environment 31 separated from the production runtime environment 11 is arranged at the operator interface unit 33 of the prototype system 30 and the prototype server unit 35, such that a restrictive separation is provided between the two runtime environments or between the production system 10 and the prototype system 30 for a test operation of the prototype system 30. The prototype runtime environment 31 is thus formed as a sandbox that is designed such that in particular the prototype applications 32, 38 of the prototype system 30 are shielded from the production system 10 so that the production system 10 remains unaffected by an operation of the prototype system 30—in particular of the individual prototype applications 32, 38—and disruptions of or, respectively, negative effects on the production system 10 are prevented. An effect of the prototype applications 32, 38 of the prototype system 30 can additionally be recorded, for example for a subsequent analysis of the prototype system 30.

The production system 10 furthermore comprises a unit 22 for system services that, for example, has a procedure (in particular a software and/or a program) for an interprocess communication as this is in particular advantageous for a common operating sequence and/or workflow of the production system 10 and of the prototype system 30. Alternatively or additionally, the unit 22 can have additional procedures and/or units that appear to be reasonable to the man skilled in the art. This unit 22 provides both the production system 10 (in particular the individual production applications 18 of the production system 10) and also the prototype system 30 (in particular the individual prototype applications 38 of the prototype system 30). The production applications 18 have an unlimited access right 21 to the procedures implemented in the unit 22 while the prototype applications 38 have only a limited access right 41 to the procedures implemented in the unit 22.

During an operation of the medical imaging system 2 a dynamic data exchange is provided between the prototype system 30 and the production system 10 (FIG. 2). The prototype system 30 hereby has a direct data access 39 to the production data of the production system 10 that are stored in the production data memory unit 17. However, in order to prevent a negative effect on the production system 10 by the prototype system 30, the data access 39 is limited so that, for example, an unwanted change and/or deletion of production data due to the data access 39 of the prototype system 30 within the production data memory unit 17 is prevented. The data access 39 is additionally configurable so that the data access 39 to the production system 10 can be adapted depending on an embodiment of the prototype system 30. A configuration of the data access 39 of the prototype unit 30 or, respectively, individual prototype applications 32, 38 of the prototype system 30 to the production data can be designed such that the prototype system 30 (in particular individual prototype applications 32, 38 of the prototype system 30) in particular has an exclusive read authorization with regard to the production data stored in the production data memory unit 17, for example. For example, it is ensured in such a manner that production data—in particular patient-related production data of the medical imaging system 2, in particular of the production system 10—are safely stored within the production data memory unit 17, and that a data loss of the production data is prevented. In an alternative embodiment of the medical imaging system 2, additional access limitations (known to the man skilled in the art) of the data access 39 by the prototype unit 30 (in particular individual prototype applications 32, 38) to the production data of the production system 10 are possible at any time.

A data access 19 of the production system 10 to the prototype data within the prototype data memory unit 37 is unlimited, as this can in particular be advantageous given common operating sequences in which at least one production application 12, 18 and at least one prototype application 32, 38 are executed. However, in principle it is also conceivable that, in an alternative embodiment of the medical imaging system 2, a data access 19 from the production system 10 to the prototype data within the prototype data memory unit 37 can be at least partially limited.

Due to the direct data access 19, 39 or data exchange between the prototype system 30 and the production system 10, common operating sequences and/or workflows are additionally possible during an execution of the prototype system 30 together with the production system 10. During a common operating sequence and/or a common workflow, individual prototype applications 38 and individual production applications 18 are executed within and/or in the prototype runtime environment 31 or within the sandbox so that an unwanted interaction with the production system 10 is prevented. In spite of the access of the prototype system 30 to individual production applications 18, the production system 10 can thus run unaffected by the prototype system 30.

Although modifications and changes may be suggested by those skilled in the art, it is the intention of the inventor to embody within the patent warranted hereon all changes and modifications as reasonably and properly come within the scope of his contribution to the art.

I claim as my invention:

1. A computerized system comprising:
a production system configured to perform a data processing task with a first system configuration that is fully tested, said production system having a production runtime environment;
a prototype system configured to perform said data processing task with a second configuration that is untested, said prototype system having a prototype runtime environment associated therewith that is separate from said production runtime environment; and
said prototype runtime environment and said production runtime environment being substantially identical.

2. A system as claimed in claim 1 wherein said production system and said prototype system are each configured to perform image data processing as said data processing task.

3. A system as claimed in claim 1 wherein said production system comprises a production system operator interface unit, and wherein said prototype system comprises a prototype system operator interface unit that is separate from said production system operator interface unit.

4. A system as claimed in claim 3 wherein said production system operator interface unit comprises a production system operator interface unit computer, and wherein said prototype system operator interface unit comprises a prototype system operator interface unit computer that is separate from said production system operator interface unit computer.

5. A system as claimed in claim 3 wherein said prototype system operator interface unit comprises at least one production application and at least one prototype application.

6. A system as claimed in claim 1 wherein said production system comprises a production system server unit, and wherein said prototype system comprises a prototype system server unit that is separate from said production system server unit.

7. A system as claimed in claim 6 wherein said production system server unit comprises a production system server unit computer, and wherein said prototype system server unit comprises a prototype system server unit computer that is separate from said production server unit computer.

8. A system as claimed in claim 1 wherein said production system comprises a production system data memory unit in which production data, generated during operation of said production system, are stored, and wherein said prototype system is configured to have direct data access to said production data stored in said production data memory unit.

9. A system as claimed in claim 8 wherein said prototype system is configured to have limited direct data access to said production data stored in said production data memory unit.

10. A system as claimed in claim 8 wherein said prototype system is configured to have at least partially configurable direct but limited data access to said production data stored in said production data memory unit.

11. A system as claimed in claim 1 wherein said prototype system comprises a prototype data memory unit in which said prototype system stores prototype data generated during operation of said prototype system, and wherein said production system is configured to have unlimited data access to the prototype data stored in said prototype data memory unit.

12. A system as claimed in claim 1 wherein said production system and said prototype system are each configured to operate according to at least one operating sequence that is common to both said production system and said prototype system, said operating sequence comprising at least one production application and at least one prototype application.

13. A system as claimed in claim 12 wherein said prototype system is configured to execute said prototype application and said production application within said prototype runtime environment.

14. A system as claimed in claim 1 wherein each of said production system and said prototype system is configured to operate a medical imaging apparatus.

15. A method for operating a computerized system, comprising:
with a production system, performing a data processing task with a first system configuration that is fully tested, said production system having a production runtime environment;
with a prototype system, performing said data processing task with a second configuration that is untested, said prototype system having a prototype runtime environment associated therewith that is separate from said production runtime environment; and
designing said prototype runtime environment and said production runtime environment to be substantially identical.

16. A method as claimed in claim 15 comprising, in said production system, storing production data, generated during operation of said production system, in a production system data memory unit, and allowing said prototype system to have direct data access to said production data stored in said production data memory unit.

17. A method as claimed in claim 16 comprising allowing said prototype system to have limited direct data access to said production data stored in said production data memory unit.

18. A method as claimed in claim 15 operating said prototype system to execute said prototype application and said production application within said prototype runtime environment.
